(19) United States
(12) Patent Application Publication
(10) Pub. No.: US 2015/0003887 A1
(43) Pub. Date: Jan. 1, 2015

(54) UPPER PEN TUBE STRUCTURE FOR PEN

(71) Applicant: DAYACOM INDUSTRIAL CO., LTD., Taipei City (TW)

(72) Inventor: Angus LEE, Taipei City (TW)

(21) Appl. No.: 13/927,895

(22) Filed: Jun. 26, 2013

(51) Int. Cl. B43K 24/04

(52) U.S. Cl. CPC B43K 24/04
USPC 401/109

(57) ABSTRACT

An upper pen tube structure for pen is disclosed, wherein the spring is covered around an outer portion of the middle column, and two ends of the spring are pressed against an outwardly protruded rim of the middle column and a stopping portion of the tube respectively. Thereby, when a control button is pressed downward to reach a lower end of a chute in order to drive the middle column to move downward, the control button can be pushed inside a hook portion in order to fix the middle column's position, and when pushing the control button back inside the chute, the middle column can be pressed and pushed against by the spring in order to move upward along the chute of the tube to reach an upper end of the chute.

### BACKGROUND OF THE INVENTION

1. Field of Invention

The present invention relates to an upper pen tube structure for pen and more particularly to an upper pen tube structure for controlling extension or retraction of a refill by pushing a control button downward or releasing the control button with the thumb.

2. Related Art

Besides the usages of writing for studying and working, pens which are delicately made and convenient to use have become precious collections for enthusiasts. For conventional pressing and rotation mechanical pens, the extension or retraction of a refill is controlled by pressing an upper pen tube, or by turning the upper pen tube and a lower pen tube relatively to each other. Thereby, users can control the extension or retraction of the refill with a single hand. A length of the mechanical pen can be maintained the same when the refill is extended or retracted. Therefore, the problem of the falling off of pen cap occurred in conventional pens can be prevented, and have the advantages of convenient to use and carry around.

However, when the above-mentioned conventional pressing mechanical pen is carried around, the pen's upper and lower ends may be easily pressed accidentally to cause the refill to extend outside of a front end of the lower pen tube. As a result, other articles may get dirty or damaged. Furthermore, for the above-mentioned conventional rotation mechanical pen, the distance for turning the pen tubes in order to cause the refill to protrude outside completely is rather long, which makes it less convenient than the pressing mechanical pen.

### SUMMARY OF THE INVENTION

In view of the above drawbacks, an upper pen tube structure for pen is provided by the present invention for causing a refill to protrude speedily by pressing a control button, and the refill can be retracted speedily by pushing the control button.

A primary objective of the present invention is to provide an upper pen tube structure for pen. Two ends of a spring disposed around an outer portion of a middle column are pressed against an outwardly protruded rim of the middle column and a stopping portion on an inner wall of a tube respectively. Thereby, when a control button is pressed downward and pushed inside a hook portion disposed at a lower end of a chute, the middle column's position can be fixed. When the control button is pushed to reach the chute from the hook portion, the middle column and the control button can be moved upward by the restoring force of the spring.

In order to achieve the above-mentioned objectives, the upper pen tube structure for pen of the present invention comprises a tube, a middle column and a spring. A chute is disposed on a lateral wall of the tube. A hook portion is extended sideway from a lower end of the chute. A stopping portion is protrudingly disposed on an inner wall of the tube. The middle column is disposed inside the tube. An outwardly protruded rim and a control button are disposed on an upper end of the middle column. The control button is penetrated through the chute and permanently fixed on the middle column. A sleeve socket is disposed at a lower end of the middle column for inserting a refill sleeve column inside the sleeve socket. The spring is covered around an outer portion of the middle column. One end of the spring is pressed against the outwardly protruded rim of the middle column; another end of the spring is pressed against the stopping portion of the tube. Thereby, the middle column can be pressed and pushed against by the spring in order to move upward; when the control button is moved upward along the chute of the tube to reach an upper end of the chute, the middle column's position can be fixed. When the control button is pressed downward to reach the lower end of the chute in order to drive the middle column to move downward, the control button can be pushed inside the hook portion in order to fix the middle column's position.

When the upper pen tube structure for pen is embodied, an anti-slipping portion is disposed on an outer circumferential surface of the control button.

When the upper pen tube structure for pen is embodied, the hook portion is disposed on the right side by the lower end of the chute.

When the upper pen tube structure for pen is embodied, a decoration cap is further disposed on an upper end of the tube.

The present invention will become more fully understood by reference to the following detailed description thereof when read in conjunction with the attached drawings.

### BRIEF DESCRIPTION OF THE DRAWINGS

FIG. 1 is a schematic combinational view of an upper pen tube structure for pen according to an embodiment of the disclosure;

FIG. 2 is a perspective view of the upper pen tube structure for pen according to the embodiment in FIG. 1;

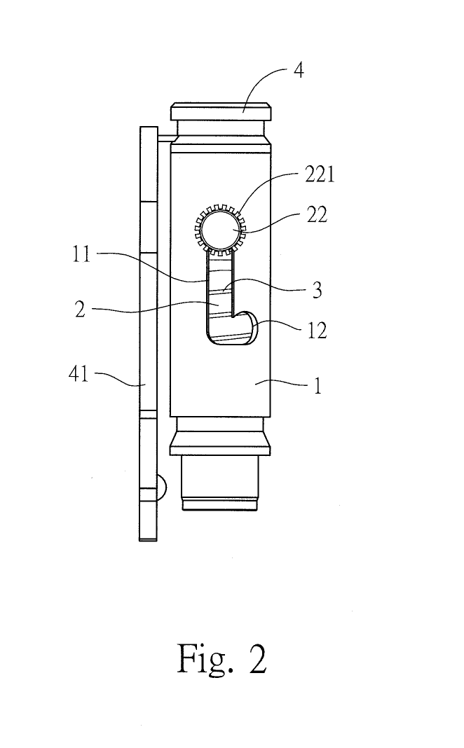

FIG. 3 is a sectional view of the upper pen tube structure for pen according to the embodiment in FIG. 1;

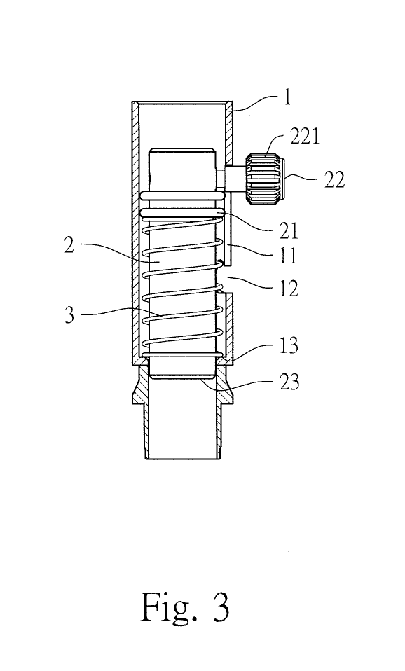

FIG. 4 is a sectional view of a control button being pushed inside a hook portion according to the embodiment in FIG. 1;

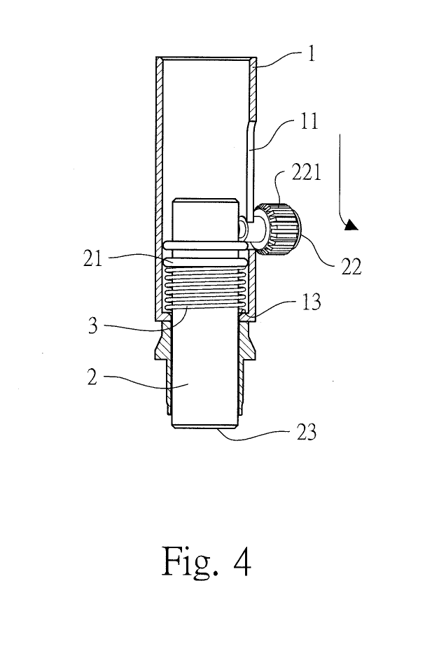

FIG. 5 is another sectional view of the control button being pushed inside the hook portion according to the embodiment in FIG. 1; and

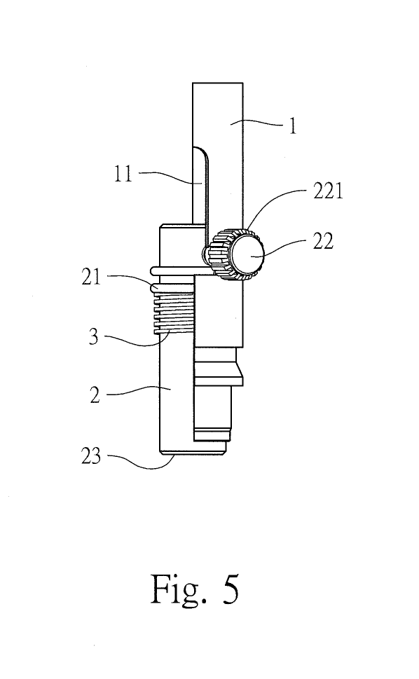

FIG. 6 is a sectional view of the control button inside the hook portion being pushed inside a chute according to the embodiment in FIG. 1.

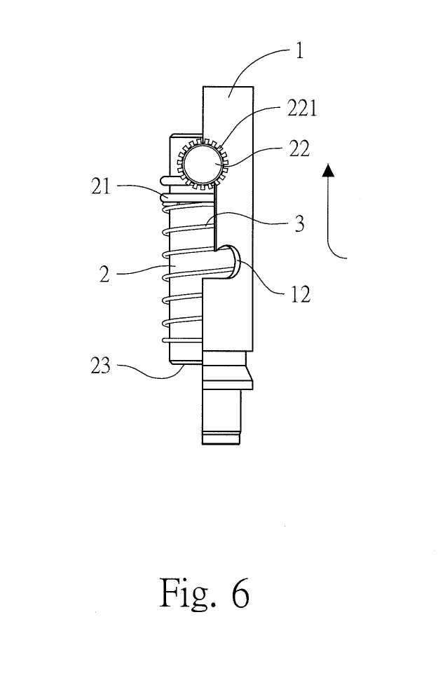

### DETAILED DESCRIPTION OF THE INVENTION

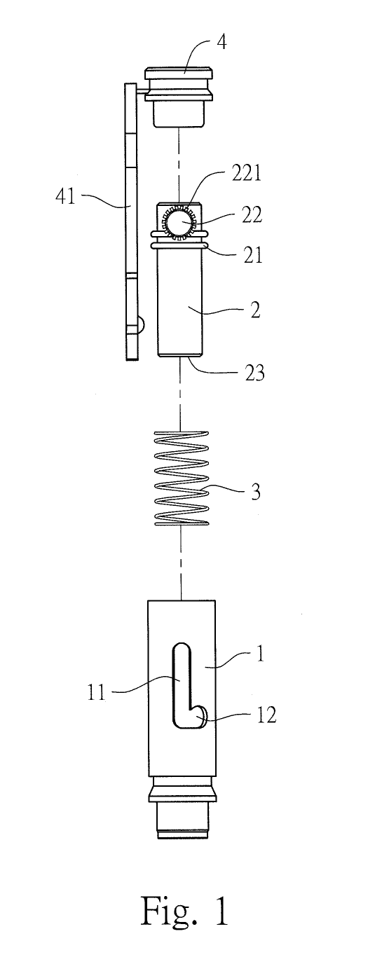

Please refer to FIG. 1. FIG. 1 shows an upper pen tube structure for pen according to an embodiment of the present invention. The upper pen tube structure for pen comprises a hollow tube 1, a middle column 2, a compression spring 3 and a decoration cap 4. An axially extending chute 11 is disposed on a lateral wall of the tube 1. A hook portion 12 is extended on the right side by a lower end of the chute 11. A stopping portion 13 is protrudingly disposed below the chute 11 on an inner wall of the tube 1.

The middle column 2 can slide upward and downward by slidably disposing inside the tube 1. An outwardly protruded rim 21 is disposed on an upper end of the middle column 2. A control button 22 is protrudingly disposed above the outwardly protruded rim 21. The control button 22 is penetrated through the chute 11 of the tube 1 and permanently fixed on the middle column 2. A sleeve socket 23 is concavely disposed at a lower end of the middle column 2. Furthermore, a gear-shaped anti-slipping portion 221 is disposed on an outer circumferential surface of the control button 22.

The compression spring 3 is covered around an outer portion of the middle column 2. An outer diameter of the compression spring 3 is smaller than an outer diameter of the outwardly protruded rim 21 of the middle column 2, and slightly smaller than an inner diameter of the tube 1. Thereby, two ends of the compression spring 3 can be pressed against the outwardly protruded rim 21 of the middle column 2 and the stopping portion 13 of the tube 1 respectively for providing a force to push the middle column 2 upward. The decoration cap 4 is inserted into an upper opening of the tube 1, and an elastic clip 41 is disposed on the decoration cap 4.

When the upper pen tube structure for pen is embodied, a lower end of the tube 1 can be used for connecting a lower pen tube of a pen. The sleeve socket 23 is for inserting a refill sleeve column (not shown in the drawings) of the pen. When a refill is required to protrude outside a lower end of the lower pen tube, the control button 22 can be pushed downward to reach the lower end of the chute 11 by the thumb in order to drive the middle column 2 and the refill sleeve column connected to the sleeve socket 23 to displace downward. Then, the control button 22 can be pushed to the right to enter into the hook portion 12 in order to fix the position of the middle column 2 and the refill sleeve column connected to the lower end of the middle column 2. The compression spring 3 is maintained at the compressed condition. When the refill is required to be retracted inside the lower pen tube, the control button 22 can be pushed to the left to reach inside the chute 11 by the thumb in order that the middle column 2 and the refill sleeve column connected to the lower end of the middle column 2 can be pushed upward by the restoring force produced by the compressed compression spring 3. When the control button 22 is moved upward along the chute 11 of the tube 1 to reach an upper end of the chute 11, the position of the middle column 2 and the refill sleeve column connected to the lower end of the middle column 2 can be fixed. Furthermore, the elastic clip 41 on the decoration cap 4 can be used for clipping the pen on a pocket.

Therefore, the present invention has the following advantages:

1. The hook portion disposed on the right of the chute is ergonomically designed in order that the control button can be pushed inside the hook portion after being pressed by the thumb. The middle column and the refill sleeve column can be released from the hook portion speedily by pushing the control button inside the hook portion by the thumb lightly in order to enhance the operability.

2. The anti-slipping portion on the control button can prevent the thumb from slipping when pushing the control button in order to enhance the practicability.

3. The problem of the refill being protruded outside of the conventional pressing mechanical pen because the pen is pressed accidentally can be prevented in order to enhance the practicability.

As a conclusion from the above mentioned descriptions, the expected objectives can be achieved by the simple structured upper pen tube structure for pen provided by the present invention which can allow the refill to be extended or retracted speedily.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. An upper pen tube structure for pen, comprising:
a hollow tube, provided with an axially extending chute being disposed on a lateral wall thereof, a hook portion being extended sideway from a lower end of the chute, and a stopping portion being protrudingly disposed below the chute on an inner wall of the tube;
a middle column disposed inside the tube, provided with an outwardly protruded rim and a control button being disposed on an upper end of the middle column, wherein the control button is penetrated through the chute and fixed on the middle column, and a sleeve socket is disposed at a lower end of the middle column for inserting a refill sleeve column; and
a compression spring being covered around an outer portion of the middle column, wherein one end of the spring is pressed against the outwardly protruded rim of the middle column, and the other end of the spring is pressed against the stopping portion of the tube to allow the middle column to be pressed and pushed against by the spring in order to move upward, and allow the middle column's position to be fixed when the control button is moved upward along the chute of the tube to an upper end of the chute, thereby when the control button is pressed downward to the lower end of the chute in order to drive the middle column to move downward, the control button is pushed inside the hook portion in order to fix the middle column's position.

2. The upper pen tube structure for pen as claimed in claim 1, wherein an anti-slipping portion is disposed on an outer circumferential surface of the control button.

3. The upper pen tube structure for pen as claimed in claim 1, wherein the hook portion is disposed on the right side by the lower end of the chute.

4. The upper pen tube structure for pen as claimed in claim 1, wherein a decoration cap is further disposed on an upper end of the tube.
